(19) United States
(12) Patent Application Publication
(10) Pub. No.: US 2021/0316169 A1
(43) Pub. Date: Oct. 14, 2021

(54) Reusable Respirator Mask Apparatus

(71) Applicant: RoddyMedical, LLC, Wauwatosa, WI (US)

(72) Inventors: Kyle Jansson, Brookfield, WI (US); Aaron Sherman, Mequon, WI (US); Kent Solberg, Whitefish Bay, WI (US); Lauren Dern, Whitefish Bay, WI (US); Patricia Deno, Dousman, WI (US); Lindsey Roddy, Wauwatosa, WI (US); Jared Koch, Fox Point, WI (US); Raman Kutty, Menomonee Falls, WI (US)

(21) Appl. No.: 17/228,964

(22) Filed: Apr. 13, 2021

Related U.S. Application Data
(60) Provisional application No. 63/009,055, filed on Apr. 13, 2020.
(60) Provisional application No. 63/033,285, filed on Jun. 2, 2020.

(51) Int. Cl. A62B 23/02; A62B 18/08

(52) U.S. Cl. CPC A62B 23/02; A62B 18/084; A62B 18/08

(57) ABSTRACT

An improved reusable respirator mask apparatus is provided. The apparatus comprises a gasket, body and head and neck strap. The gasket is configured to provide comfort to a user, maintain a reliable airtight seal and allow a user to wear glasses while also using the mask. Further the mask is configured to receive multiple types of filter media, provide minimal rebreathing, be easily cleanable and allow visual communication of a user's facial expression.

### CROSS REFERENCE TO RELATED APPLICATIONS

U.S. Provisional application No. 63/009,055, filed on Apr. 13, 2020, and U.S. Provisional application No. 63/033,285, filed on Jun. 2, 2020.

### BACKGROUND

Face masks passing the National Institute for Occupational Safety and Health (NIOSH) N95 particle filtration standards are used to filter small micron-sized particles, such as viruses and bacteria, while breathing. Masks rated as meeting or exceeding NIOSH N95 standards are preferred by standard health care professionals, first responders, hazmat, commercial and home use when exposed to people with airborne infectious diseases because the masks (or more specifically their filtering material) are capable of filtering at least 95% of 0.3 micron or larger particles. These masks cover the nose and mouth and create an impermeable seal against the face that limits airflow to the filtration media used in the mask. While a variety of face mask solutions exist which meet NIOSH N95 standards, they have serious drawbacks ultimately causing difficulty for users in completing their jobs. For example, some face mask designs meeting NIOSH N95 standards consist entirely of filtration media material and are not comfortable for long term wear, are difficult to wear with glasses or goggles, and do not allow people to understand the facial expression of the mask wearer. While these types of masks can be cleaned, the cleaning process in turn degrades the quality of the filtration and inhibits breathability through the filtration material as a result. Because of this, these masks are often regarded as a one-time use, disposable product. This product lifecycle design leads to a great deal of waste-both in terms of discarded masks and inefficient use of materials due to the amount of filtration media necessary to build a single mask, resulting in an increased likelihood of deficiency in product availability and manufacturing ability during times of high need, such as during a global pandemic.

### SUMMARY

The current invention solves the problems noted above and many more by creating a reusable respirator mask comprised of a gasket, an impermeable body configured to receive a filter, an adjustable strap clip and an upper head and neck strap which can all can be cleaned without compromising the integrity of the filtration media or the ease of a user breathing through the mask. Further, the invention reduces the amount of filtration media needed per mask as well as provides increased compatibility with most readily available filtration media and form factors. The gasket and body are designed to seal the edges of the mask to the face, restricting the flow of all air inhaled and exhaled by a user to pass through the filter. The present invention is a high-quality filtration mask that is safe to use, robust, conformable, cleanable, seals to the face, reusable, and comfortable while being able to be manufactured quickly and can be made compatible with most available filters.

The reusable filtration mask has the following features/benefits:

1. Comfortable—Does not leave pressure sores on the face when in use for long periods of time. The mask allows continuous, daily use without pain or discomfort.

2. Compatibility—Faces are all different shapes and sizes. Creating a one-size-fits-all mask is a difficult task. Creating various unique gasket and body shapes provides compatibility for a majority of all individuals.

3. Cleanable—The masks shall be able to be cleaned with soap and water, or 70%+ alcohol, or other bacterial or viral cleaning chemicals such as those found in hospitals and not require expensive UV light cleaning stations. UV cleaning stations may be used, if available. Furthermore, parts shall be made from shapes with smooth accessible surfaces to allow germs or debris to be visibly wiped away without “hiding” places such as crevices, rough surfaces, or inaccessible locations. Parts shall be able to be disassembled and reassembled quickly and easily.

4. Safe Materials—Made with medical grade materials to prevent the growth of bacteria and debris on the surfaces of materials that will not break down. The purpose of this is to follow good design practices as to not cause unintentional side effects or harm by providing a person with a product that may cause infection, skin irritation, or allergic reactions. Furthermore the filtration media must be safe for direct human inhalation and not allow debris to break off and enter the lungs to potentially cause serious adverse or long-term health side effects. Materials shall be skin safe and approved for human inhalation use.

5. High Quality of Air Filtration—To prevent the spread of infectious diseases the mask will be held to an analogous standard to the current gold-standard, which is the NIOSH N95 rating. This rating is capable of filtering at least 95% of 0.3 micron or larger particles, or hospital grade bacterial or viral filtration standards of at least 95%+ percent of viral or bacterial particles. We say analogous as some ventilator breathing filters are used in hospital settings with a different set of viral and bacterial efficiency. To summarize, the filtration will match the allowable standards as required for use in a clinical setting to prevent the spread of an infectious disease.

6. Replaceable Filtration Media—Filtration media wears out over time and leads to waste. As the filter is used and its useable life ends, it shall be discarded and replaced, and the mask shall be cleaned and reused. There shall be an emphasis on the size of the filtration media used to maximize the available supply chain resources and to minimize the mass of the waste when this is discarded.

7. Airtight Seal against Face—Passes clinical fit tests, also known as saccharine tests, to ensure that air is entering and exiting only through the filter media.

8. Breathable—Ensures a pressure drop common to NIOSH N95 mask standards of less than 25 mm H2O of water pressure with a flowrate of air at 85 LPM through the filter media.

9. Adjustable head and neck strap—Allow conformable, stable, robust, quick, and easy adjustment to pull the mask onto the face and keep it in place when the user is talking, moving their head, and moving their body when bowing or leaning sideways. The strap also helps maintain the integrity of the seal against the face during use, including if the mask is bumped. The strap shall not slide along hair or skin and shall stay in place.

10. Allow for Eyeglasses to be worn—The nose area shape of the gasket and body are comfortable for use with eyeglasses without breaking the seal against the face and allows for normal intended and proper positioning of glasses or goggles.

11. Sizes—Can be made in multiple sizes including a small, medium, large for children to adults.

12. Fit under face shield—The mask and filter are useable with a common face visor or face shield. The exhalation through the filter does not fog up a face shield nor require modifications of the face shield to be used, such as cutting it out around the mask or at the filter inlet.

13. Built-In Face shield or eye protection—The mask may allow for a face shield visor or eye protection to be added into the design of the mask.

14. Minimal rebreathing—The mask volume is small in size and volume to prevent CO2 build up beyond unsafe levels of breathability.

15. The mask is designed to allow individuals to understand the facial expression, such as a smile, of the mask wearer.

16. Minimal parts—In times of low supply and high demand manufacturers and users can quickly produce individual parts as needed.

### BRIEF DESCRIPTION OF THE DRAWINGS

FIG. 1 is a front perspective view of an embodiment of the present invention;

FIG. 2 is a rear perspective view of an embodiment of the present invention;

FIG. 3A is a front view of an embodiment of gasket 102;

FIG. 3B is a rear view of an embodiment of gasket 102;

FIG. 3C is a rear perspective view of an embodiment of gasket 102;

FIG. 3D is a front perspective view of an embodiment of gasket 102;

FIG. 4A is a front perspective section view taken along line 4-4 of FIG. 3D;

FIG. 4B is a side section view taken along line 4-4 of FIG. 3D;

FIG. 5A is a side view of an embodiment of body 104;

FIG. 5B is a front view of an embodiment of body 104;

FIG. 5C is a rear view of an embodiment of body 104;

FIG. 5D is a front perspective view of an embodiment of body 104;

FIG. 6A is a top view of an embodiment of upper head strap and neck strap 110;

FIG. 6B is front perspective view of an embodiment of upper head strap and neck strap 110;

FIG. 7A is a bottom view of an embodiment of adjustable strap clip 108;

FIG. 7B is a top perspective view of an embodiment of adjustable strap clip 108;

FIG. 8 is a cross-sectional view of adjustable strap clip 108 and first side 164 and second side 166 of strap 110 in a connected state;

FIG. 9A is a front view of an alternative embodiment of gasket 102;

FIG. 9B is a bottom perspective view of an alternative embodiment of gasket 102;

FIG. 9C is a rear view of an alternative embodiment of gasket 102;

FIG. 9D is a front perspective view of an alternative embodiment of gasket 102;

FIG. 10A is a front perspective section view taken along line 10-10 of FIG. 9D;

FIG. 10B is a side section view taken along line 10-10 of FIG. 9D;

FIG. 11A is a side view of an alternative embodiment of body 104;

FIG. 11B is a front view of an alternative embodiment of body 104;

FIG. 11C is a front perspective view of an alternative embodiment of body 104;

FIG. 11D is a rear view of an alternative embodiment of body 104;

FIG. 12 is a perspective view of an embodiment of filter 114;

FIG. 13 is a section view of an embodiment of body 104 and gasket 102 taken along line 13-13 of FIG. 1;

FIG. 14 is a front view of an alternative embodiment of the present invention;

FIG. 15 is a rear view of an alternative embodiment of the present invention;

FIG. 16 if a front view of an alternative embodiment of gasket 102;

FIG. 17 is a rear view of an alternative embodiment of gasket 102;

FIG. 18 is a section view along line 18-18 of FIG. 15;

FIG. 19 is a front view of an alternative embodiment of body 104;

FIG. 20 is a bottom view of an alternative embodiment of body 104;

FIG. 21 is a rear view of an alternative embodiment of body 104;

FIG. 22 is a front perspective view of an alternative embodiment of the invention; and

FIG. 23 is a bottom perspective view of an alternative embodiment of the invention.

### DETAILED DESCRIPTION OF THE INVENTION

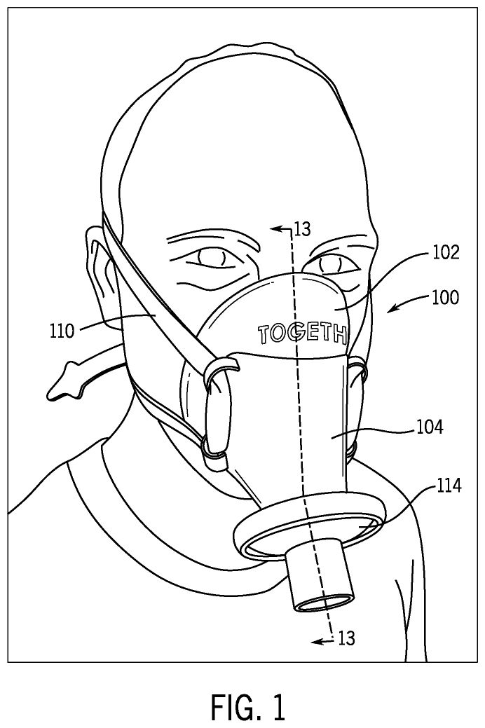

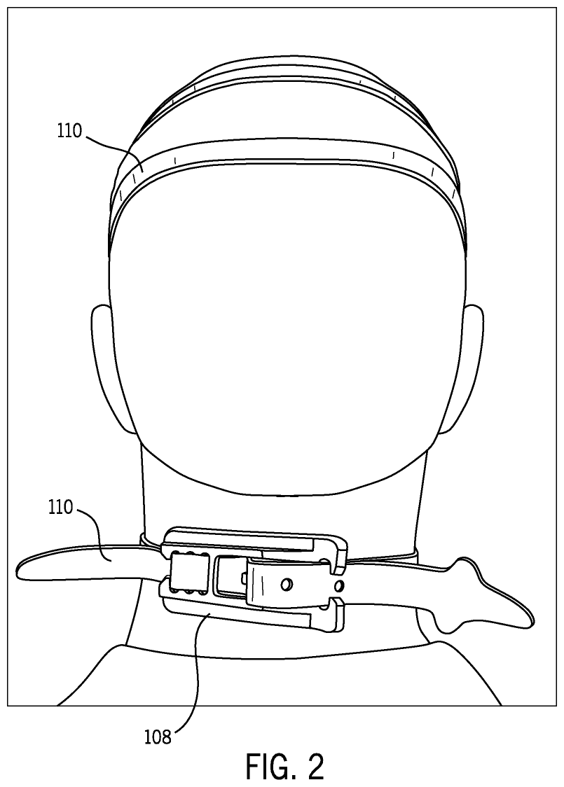

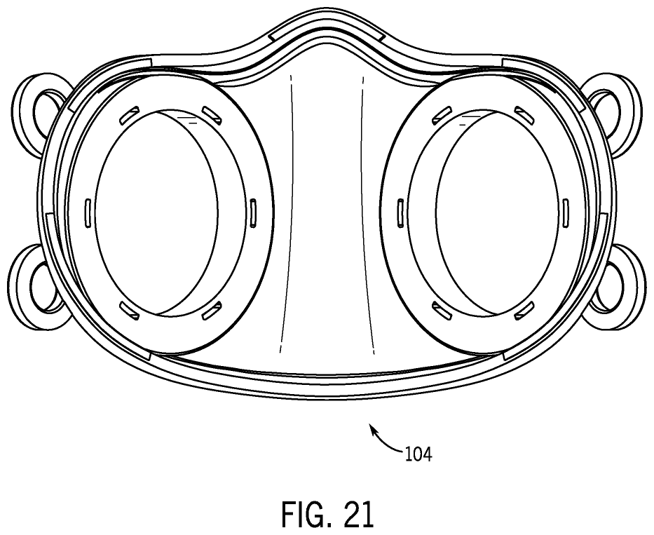

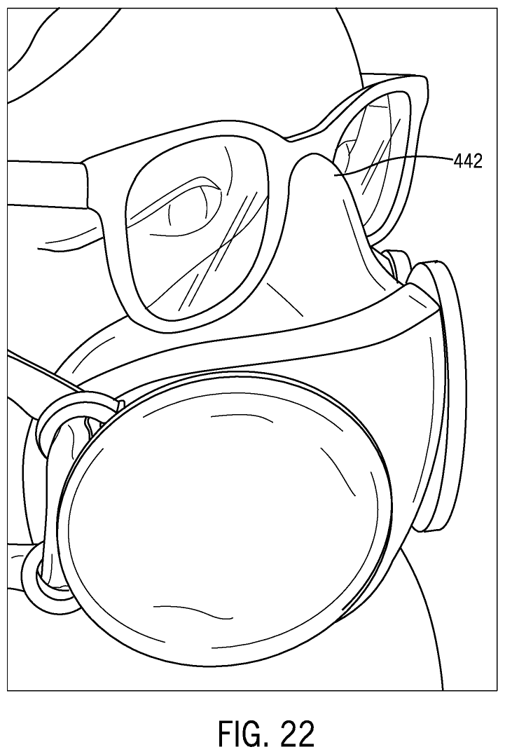

A reusable respirator mask apparatus will now be described with references in FIGS. 1-23. Turning to the drawings, where the reference characters indicate corresponding elements throughout the several figures, attention is first directed to FIG. 1 where a front perspective view of an embodiment of the invention is shown and FIG. 2, where a rear perspective view of an embodiment of the invention is shown, illustrating its composition and the apparatus is generally indicated by reference character 100. Improved reusable respirator mask apparatus 100 comprises a gasket 102, a body 104, an adjustable strap clip 108, and upper head and neck strap 110, wherein at least one filter or filter media 114 removably plugs into body 104, thereby providing air filtration to a user. Further, upper head and neck strap 110 connects to body 104 and adjustable strap clip 108 thereby allowing mask 100 to be secured to a user's face.

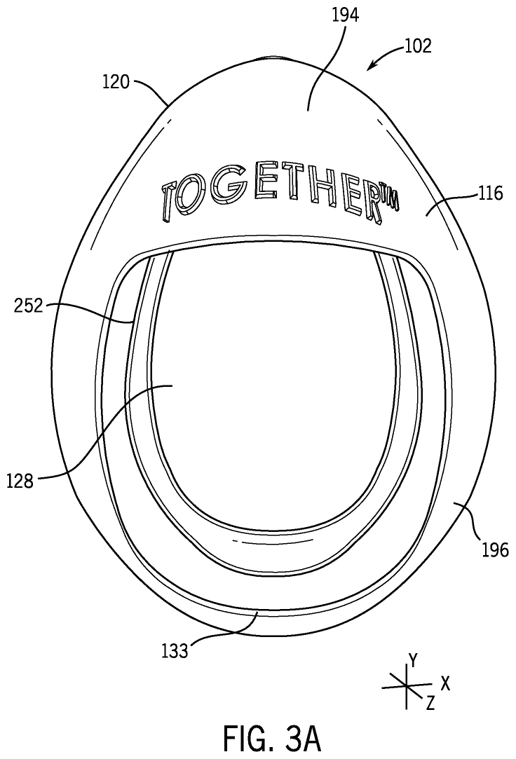

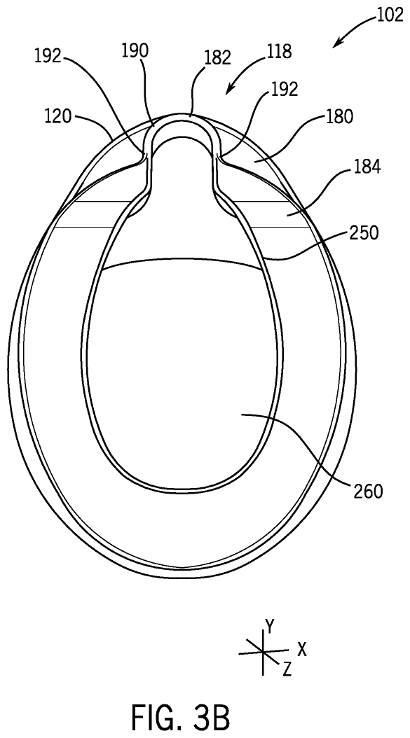

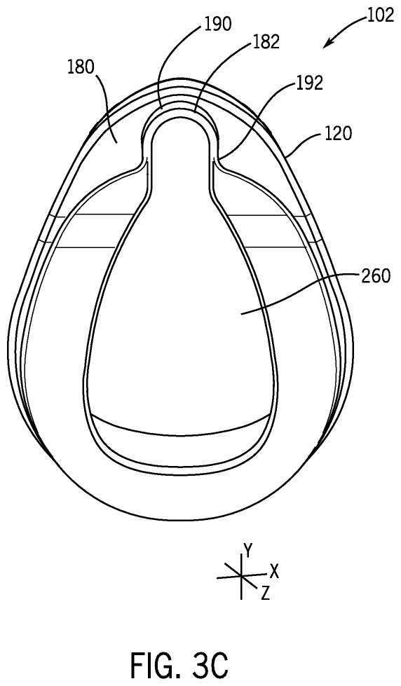

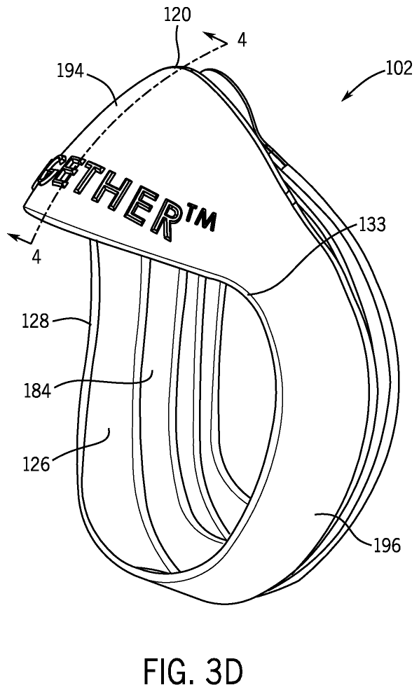

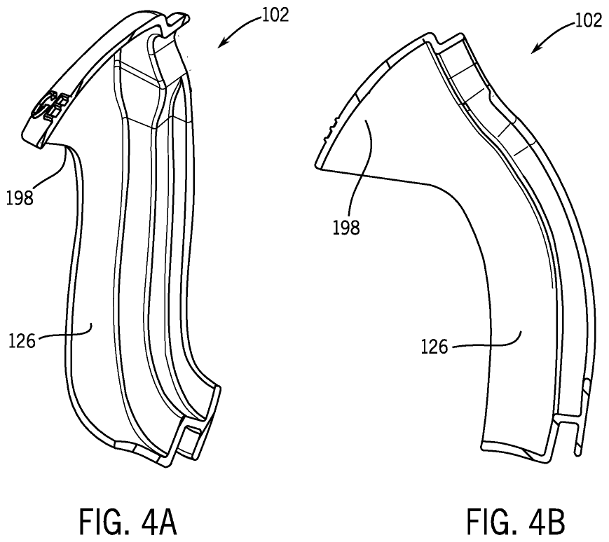

Turning to FIGS. 3A-3D show a front, rear, rear perspective and front perspective view of an embodiment of gasket 102 while FIG. 4A and FIG. 4B show a front perspective and side section view taken along line 4-4 of FIG. 3D. Gasket 102 is generally elliptical and cup shaped, configured to removably attach to at least a portion of a user's face surrounding their nose and mouth and may include a person's cheeks and chin as well. Gasket 102 is comprised of top face 116 and bottom face 118, and inner recess 128 formed therethrough and circumscribed by edge 133. Bottom face 118 further comprises a first bottom face lip 180 which is a vertical elliptical shape in the X and Y direction to an outer peripheral edge 120, extending around the perimeter of top face 116 of gasket 102, where peripheral edge 120 is widest near the middle or slightly below the middle of gasket 102. First bottom face lip 180 is a consistent width around the perimeter of gasket 102 except along the top of gasket 102, where first bottom face lip 180 is shaped as an edge of a extended round or semicircular shape 190 in order to accommodate a user's nose and glasses. Preferably first bottom face lip 180 reduces in width at the top of gasket 102 at shape 190 and widens throughout the rest of lip 180. Bottom face 118 further comprises ridge 182 extending out from first bottom face lip 180 and perpendicular to it. Bottom face 118 further comprises a second bottom face lip 184 with an inner edge 250 wherein lip 184 extends perpendicular to ridge 182 (and parallel to first bottom face lip 180) toward peripheral edge 120, starting at points 192 on ridge 182 and extending elliptically toward peripheral edge 120 and extending around to the bottom of gasket 102. Ridge 182 and inner edge 250 form a bowling pin with a short neck shaped aperture 260 formed therethrough which extends to inner cavity 128. Second bottom face lip 184 is a smaller width than first bottom face lip 180. Turning to FIG. 4A and FIG. 4B, bottom face 118 extends in a “Z-shape” or partial elliptical fashion in the Z-axis to provide an air-tight seal on a variety of facial shapes.

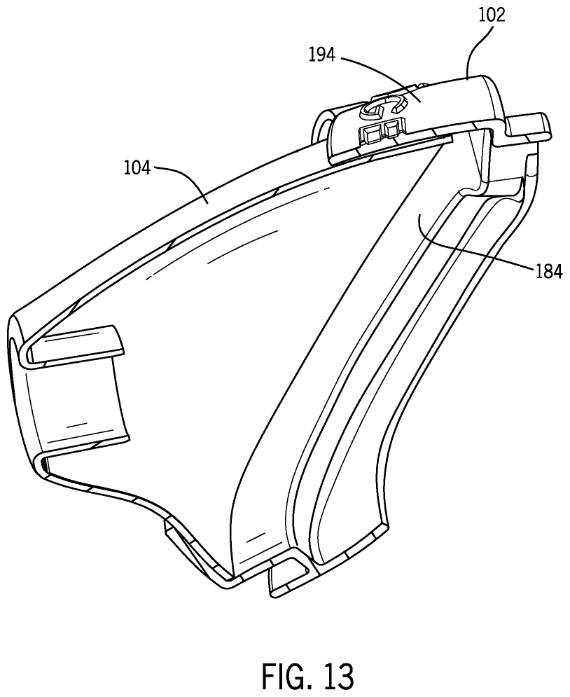

Top face 116 is further comprised of hood 194 with an inner hood surface 198, lower portion 196 with inner lower portion surface 126, peripheral edge 120 and inner recess 128 formed therethrough gasket 102. Top face 116 and bottom face 118 connect at peripheral edge 120. Peripheral edge 120 may be rounded and/or tapered away from bottom face 118 to ensure a person will desire to secure gasket 102 tightly to their face by upper head and neck strap 110. Inner recess 128 is also elliptical and cup shaped and allows access for edge 132 of body 104 to come in physical contact or overlay with inner hood surface 198 and lower portion surface 126 of gasket 102 as well to position body 104 abut the bottom surface of bottom face lip 184, thereby removably securing gasket 102 on top of and to body 104 due to the a properly designed geometry and fit between the gasket and body, or an adhesive material properties of gasket 102 as well as the large surface area provided by body 104. Further, if desired gasket 102 may be overmolded onto body 104, thereby permanently affixing gasket 102 and body 104 together, making cleaning easier and more efficient as well as guaranteeing an airtight seal between gasket 102 and body 104 through a chemical bond. Turning to FIG. 13, a section view of an embodiment of body 104 and gasket 102 taken along line 13-13 of FIG. 1, illustrating how gasket 102 and body 104 overlap. Gasket 102 is made from an elastomer material (preferably single layer), such as a soft durometer medical grade silicone, such as 20 durometer shore A grade with a wall thickness of greater than 0.060 inches and less than 0.10 inches with a preferred thickness of 0.085 inches to ensure a secure and comfortable fit. Other durometers or materials such as polyurethane foams which are closed cell, wipeable, and non-porous leaving a smooth surface could be used as well, as long as the gasket can seal fully around the face. Gasket 102 is a very soft conformable part that spreads the load of improved mask apparatus 100 against user's a face through a large surface area (via first bottom face lip 180, second bottom face lip 184 and ridge 182), which reduce the pressure on the users face and improves comfort for the user. Gasket 102 also removes any airgaps which may normally occur between a user's face and the harder thermoformed body 104. Further, since gasket 102 is within the “wetted path” of airflow into the lungs, care must be taken to ensure a proper material does not harm the user.

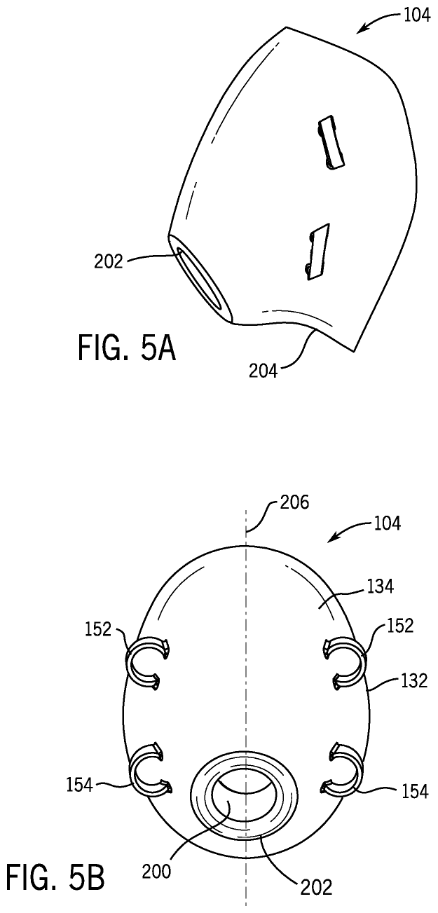

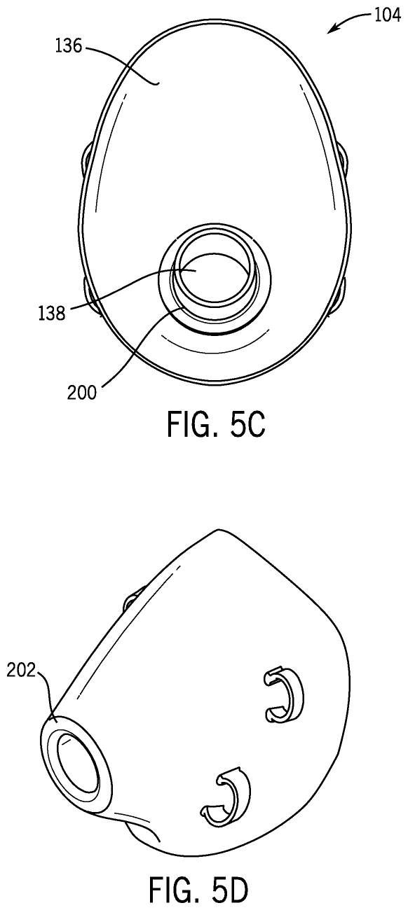

Turning to FIGS. 5A-5D, a side, front, rear and front perspective view of body 104 is shown. Body 104 is a stubby tapered cup shaped, tapered at an angle greater than 21 degrees, with at least one line of symmetry 206 and configured to cover at least a person's nose and mouth but may also include their cheeks and chin. Body 104 comprises a top surface 134, curvature 204, peripheral edge 132 which extends around perimeter of body 104, inner cavity 136, lip 202, aperture 138 formed therethrough body 104 and inlet 200. Aperture 138 is formed in the lower or “chin” portion of surface 134, surrounded by lip 202, and protrudes into inlet 200 which extends into inner cavity 136. Inlet 200 is a tapered cylinder shape configured to easily and securely create an airtight seal with filter or filter media 114, making filter insertion into aperture 138 and inlet 200 quick and easy for a user. Inlet 200 makes an airtight seal with filter 114 via an interference fit but may also utilize other known methods such as threaded fit, glue, dovetail, snap ring, snap fit, accordioned fit, spring and/or magnetic. Inlet 200 is preferably 0.90 inches in diameter where it connects to lip 202 (and likewise lip has an inner diameter of 0.90 inches) and tapers to 0.87 inches where it terminates inside inner cavity 136, providing secure airtight connection with a filter 114 or filter media connection converter that is a nominal 22 mm in diameter but inlet 200 and filter 114 may be any desired diameter. Further, aperture 139 is aimed in a downward direction thereby aiming exhaled air away from a user's glasses, goggles and/or face shield, thereby preventing fogging of the glasses, goggles and/or face shield, a common problem found in face masks. Curvature 204 is located below aperture 138 and contours to provide a comfortable and secure fit to a user's chin area. The material for Body 104 is smooth, rigid or semi-rigid, cleanable, wipeable, and airtight as well. In addition, since body 104 is within the “wetted path” of airflow into the lungs, care must be taken to ensure a proper material does not harm the user. Below aperture 138 Body 104 is injection molded from commonly available medical grade plastic. Body 104 is small enough to allow a user to communicate facial expressions to a patient however body 104 may also be clear or translucent in order further let a user communication facial expression easier and may include an anti-fog coating. For example, children are less intimated when they can see facial expressions of a person.

Body 104 further comprises at least two head strap mounting positions 152 where each are located in-line with one another on opposing sides of top surface 134 and each located near the top of body 104 equidistant from line of symmetry 206. Body 104 further comprises at least two neck strap mounting positions 154 where each are located in-line with one another on opposing sides of top surface 134 and each located near the bottom of body 104 equidistant from line of symmetry 206. Positions 152 and 154 are formed integral with body 104 and are circular, preferably a diameter of 0.24 inches. Strap 110 is in communication with positions 152 and 154, comfortably sliding through head strap mounting positions 152 to secure the upper portions of gasket 102 and body 104 to a user's head and strap 110 comfortably slides through neck strap mounting positions 154 and removably attach to adjustable snap clip 108 to secure the lower portions of gasket 102 and body 104 to a user's neck. It is contemplated positions 152 and 154 may be any shape desired to secure strap 110 to body 104. Body 104 is a preferred thickness of 0.60 inches and preferably made from a semi-rigid material such as PETG or polycarbonate but the thickness and material may vary depending on the desired application and environment mask 100 will be used in.

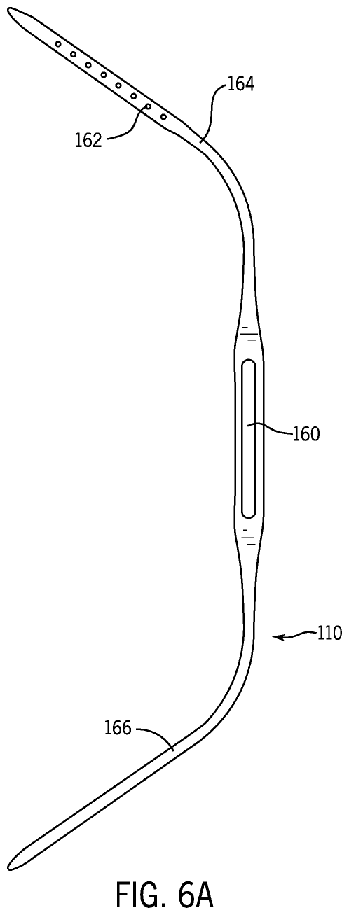

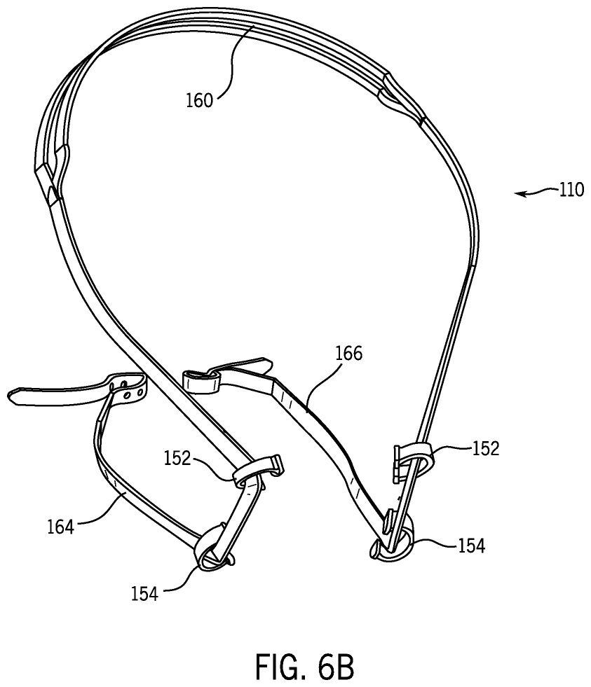

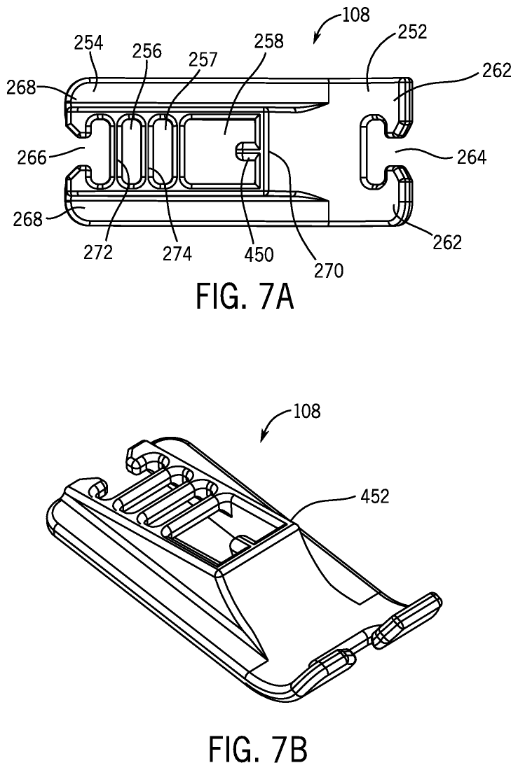

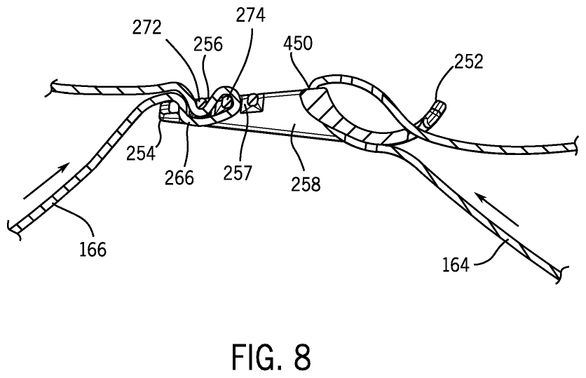

Turning to FIGS. 6A and 6B, a top view of an embodiment of upper head strap and neck strap 110 and a front perspective view is shown. Strap 110 can be made from any elastomer which is skin safe and FDA approved. For example a 50 durometer silicone material may be used. Strap 110 is generally rectangular in shape and includes a first side 164, second side 166 and an orifice 160 formed therethrough and located in the middle of strap 110. Orifice 160 better situates strap 110 on the crown of a user's head and better supports the weight of mask 100 (see FIGS. 1-2). First side 164 further comprises at least one neck aperture 162 formed therethrough in order to allow a user to quickly attach at least first side 164 of strap 110 to peg 450 on adjustable snap clip 108 (see FIGS. 7A and 7B). Second side 166 removably connects to adjustable snap clip 108 as well, thereby additionally securing mask 100 to a user's neck and is flexible to maintain the seal of gasket 102 on the user's face—like a string—for when the user is talking or moving their head or leaning to the side or forward, gasket 102 will maintain the integrity of the seal created between gasket 102 and a user's face. Further, FIG. 8 shows how strap 110 threads through head strap mounting positions 152 and neck strap mounting positions 154 on body 104 to secure body 104 and gasket 102 to a user's face in a single, easily removably, adjustable and cleanable strap.

Turning to FIGS. 7A and 7B, a bottom view and top perspective view of an embodiment of adjustable strap clip 108 is shown. Clip 108 comprises first hook 252 on one end and a fastening structure 452 on the other end wherein fastening structure 452 further comprises peg 450. First hook 252 and fastening structure 260 are formed integral to clip 108. First hook 252 further comprises a passage 264 formed therethrough first hook 252 and two tapered prongs 262 located on each side of passage 264. Fastening structure 452 is a wedge shape with a concave shaped base. The tip of fastening structure 452 further comprises second hook 254, at least two small orifices 256 and 257 obround shaped and inline with and next to hook 254 which form first post 272 and second post 274, and large orifice 258 rectangular shaped and inline with and next to small orifice 257, wherein orifice 258 further comprises a rear wall 270 with a peg 450. Peg 450 is located centrally and extends away from rear wall 270. Second hook 254 further comprises a passage 266 formed therethrough second hook 254 and two tapered prongs 268 located on each side of passage 266. First hook 252 and second hook 254, passage 264 and passage 266 as well as tapered prongs 262 and tapered prongs 268 may be the same size and shape characteristics as one another.

Turning to FIG. 8, a cross-sectional view of adjustable strap clip 108 and first side 164 and second side 166 of strap 110 in a connected state is shown. Strap 110 attaches to clip 108 initially by first side 164 enters through the bottom of large orifice 258, over peg 450, through the top of hook 252 and is held inside passage 264 by prongs 262 where the desired neck aperture 162 is removably fastened or pressed onto peg 450. Second side 166 of strap 110 is removably connected to clip 108 by cinching around post 272 and post 274. Second side 166 of strap 110 initially threads through the top of passage 266 of second hook 254 and extends through the bottom of passage 266 and threads into and through orifice 257 and wraps around post 274, threads under post 272 and extending back through passage 266 and held in place by prongs 268. When a user pulls on second strap 166 it will be secured to clip 108, thereby allowing a user to custom fit a mask 100 to their specific face and head characteristics for a secure and comfortable fit.

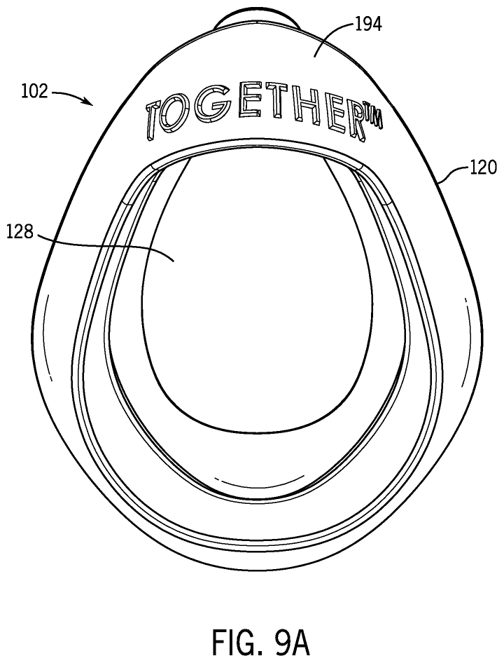

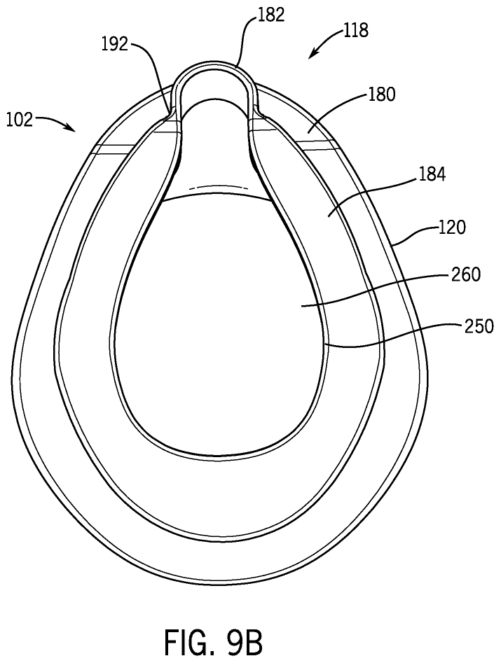

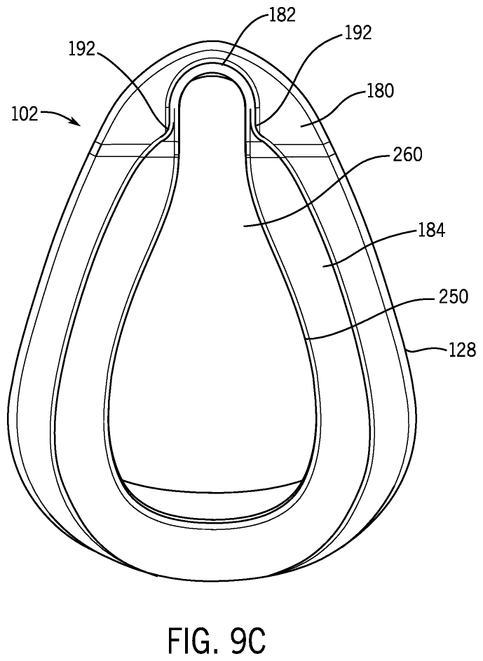

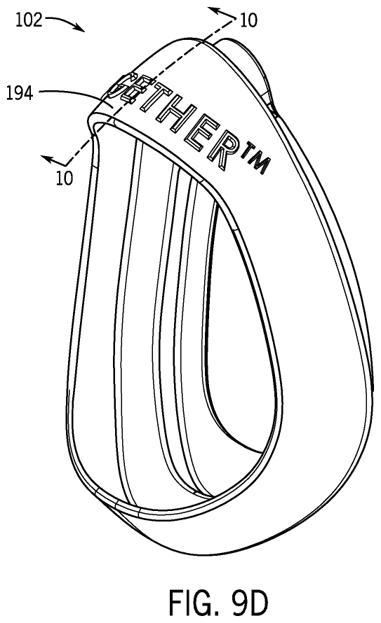

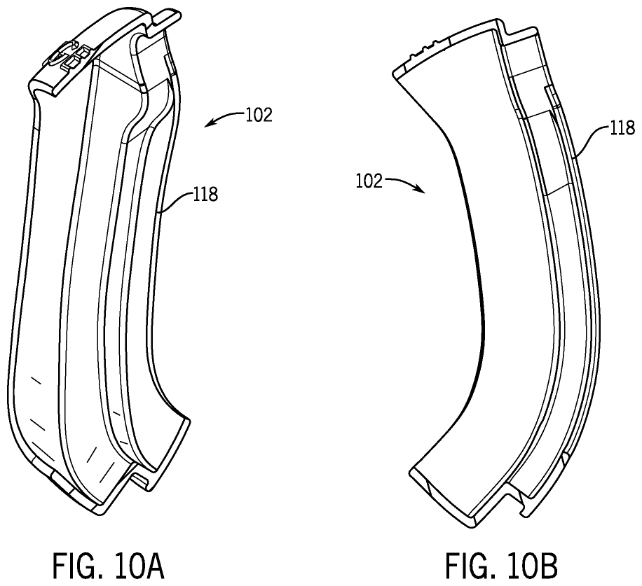

Turning to FIGS. 9A-9D, a front, bottom perspective, rear and front perspective view of an alternative embodiment of gasket 102, while FIGS. 10A and 10B shows a front perspective and side section view taken along line 10-10 of FIG. 9D. Through great effort and experimentation, it has been found that most individuals will fit one of two gasket shapes (and likewise body shapes) with the first being described above. This second, or alternative embodiment of gasket 102 contains all the elements described above but the differences described below. Such differences will be discussed below. The alternative embodiment of gasket 102 is generally teardrop and cup shaped, configured to removably attach to at least a portion of a user's face surrounding their nose and mouth and may include a person's cheeks and chin as well. First bottom face lip 180 which is a vertical teardrop shape in the X and Y direction and extends to peripheral edge 120, around the perimeter of gasket 102, where the gasket 102 is widest near the bottom of said gasket. Second bottom lip 184 is also teardrop shaped. Ridge 182 and inner edge 250 form a bowling pin with a long neck shaped aperture 260 formed therethrough which extends to aperture 128. Turning to FIGS. 10A and 10B, bottom face 118 extends in a “J-shape” or curved fashion in the Z-axis to provide an air-tight seal on a variety of facial shapes. Top face 116 is further comprised of a smaller hood 194 with smaller inner hood surface 198.

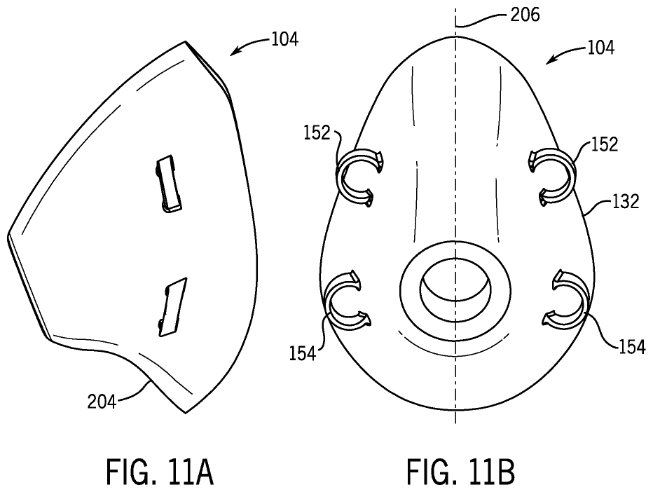

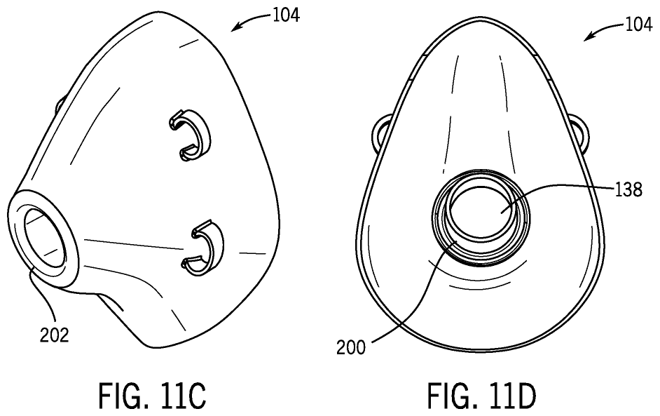

Turning to FIGS. 11A-11D, a side, front, front perspective and rear view of an alternative embodiment of body 104 is shown. This alternative embodiment of body 104 contains all the elements described above but the differences described below. Alternative embodiment of body 104 is a tapered cup shaped, tapered at an angle less than 21 degrees with at least one line of symmetry 206 and configured to cover at least a person's nose and mouth but may also include their cheeks and chin.

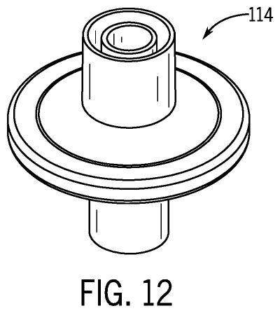

Turning to FIG. 12, a perspective view of an embodiment of filter or filter media 114 is shown. In this embodiment at least one layer of filter media is enclosed within the cartridge alone with an orifice located on either side of filter media. It is contemplated other filter cartridge sizes may be configured to operate with inlet 200 of body 104, or inlet 200 may be configured to securely hold filter media itself without an outer casing. While the present invention has been described above in terms of specific embodiments, it is to be understood that the invention is not limited to these disclosed embodiments. Many modifications and other embodiments of the invention will come to mind of those skilled in the art to which this invention pertain, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

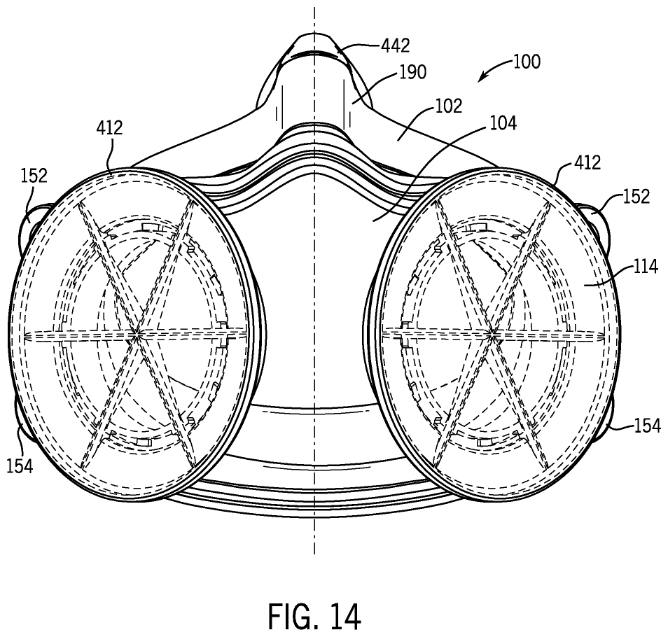

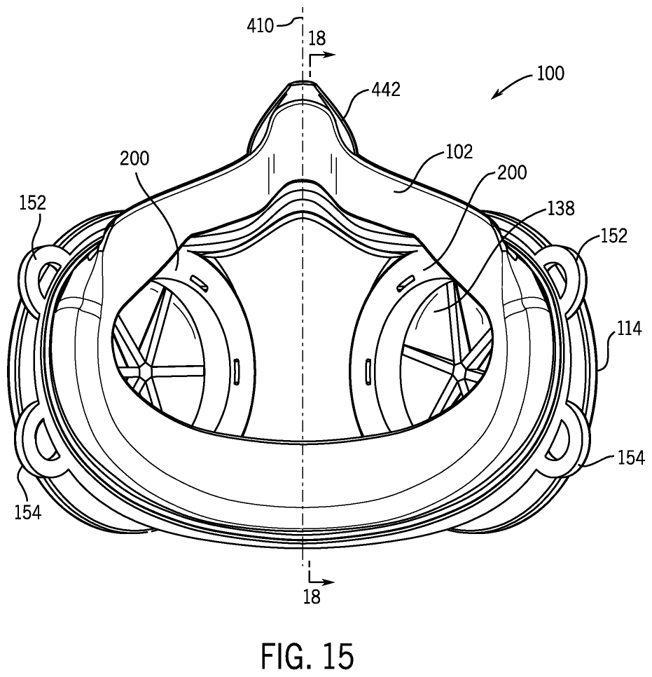

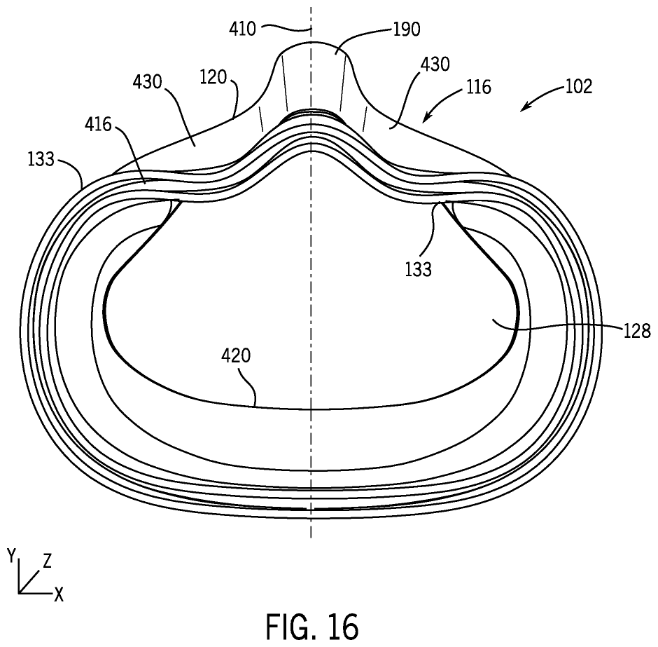

Turning to FIG. 14 and FIG. 15, a front and rear view of an alternative embodiment of the present invention is shown. In this embodiment body 104 has at least two apertures 138 formed therethrough (preferably 1.74 inches in diameter but any desired diameter can be used which maintains the design characteristics of the invention), wherein each aperture 138 has an inlet 200 configured to receive a filter cartridge or filter media 114. This larger aperture size (as compared to the embodiment show in FIG. 1 has been found to make it easier for patients/others to hear the speech of the person wearing mask 100. Each inlet is preferably 0.24 inches tall but can be any desired height extends perpendicular away from body 104 at least enough distance to allow a filter cartridge or filter media 114 to securely connect with each inlet 200 to create an airtight seal. It is also contemplated inlet 200 may extend inside of body 114. If a filter media 114 is used without a media containment cartridge, then a cap 412 can be used to locked filter media 114. One way for cap 412 to lock or sandwich filter media 114 to inlet 200 is by further configuring inlet 200 to include at least two nubs 414 which are located along the edge of and extend perpendicular to the edge of inlet 200. Cap 412 can be configured with openings formed therethrough about the inner diameter of cap 412 to match and screw onto nubs 414 so there is an airtight seal. Cap 414 is further configured with an aperture formed therein to allow one side of filter media 114 to be exposed to the air and the other side to be exposed to the breath of the mask wearer. It is contemplated any known way to secure filter media to inlet 114 so there is an airtight seal may be used. Each inlet 200 is located on opposing sides of body 104, ideally equidistant from centerline 410. Further, body 104 may be clear or transparent in order to allow people to interpret facial expressions of the mask wearer. The ability to see the facial expression of a mask wearer has been found to be important to high quality patient care as well as the ability to convey information such as safety and empathy to a patient. Further, body 104 and gasket 102 are symmetrical about centerline 410. However, in order to accommodate different face sizes and dimensions mask 100 may be scaled larger or smaller as long as the dimensional ratios are maintained. Gasket 102 may optionally include additional material 442 to extend semicircular shape 190 to cover and surround the nasal bridge of a human user in order to maintain an airtight seal when mask 100 is used by individuals with small or “flatter” noses. In the preferred embodiment additional material 442 extends shape 190 0.4 inches away from gasket 102 and follows the contour of each side of shape 190 approximately 1.1 inches, although the dimensions of additional material 442 may be altered to the desired gasket shape.

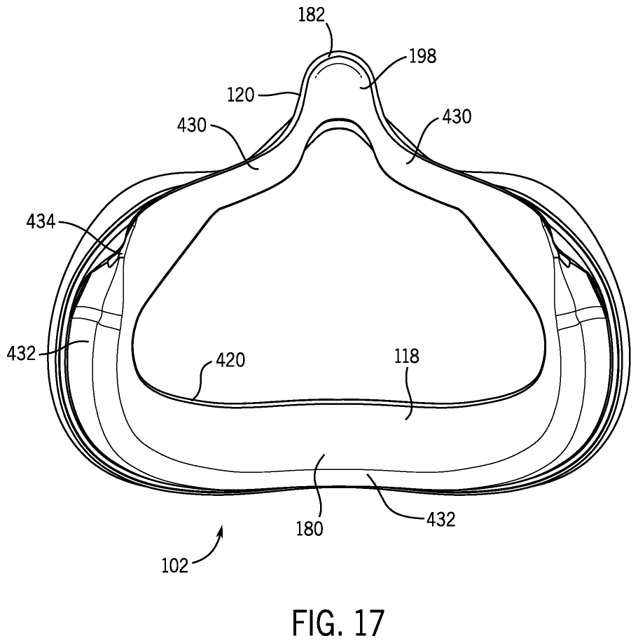

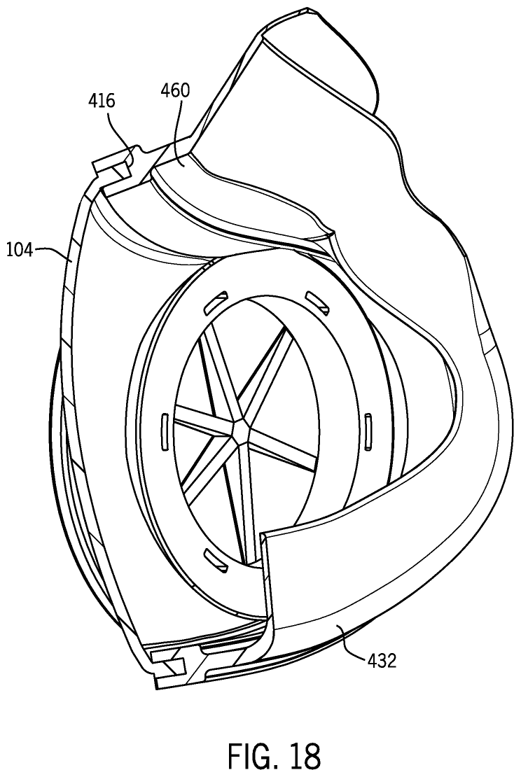

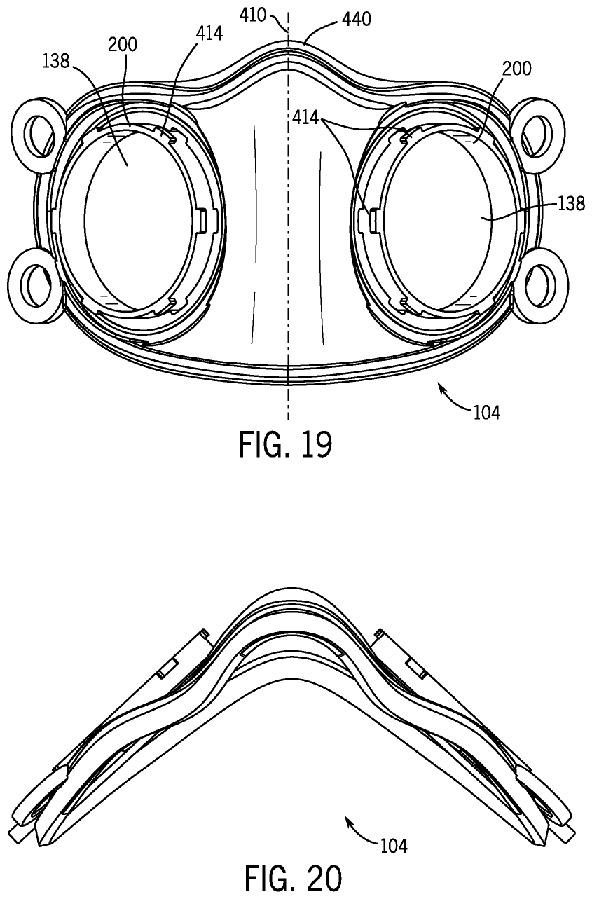

Turning to FIG. 16 and FIG. 17, a front and rear view of an alternative embodiment of gasket 102 from FIGS. 14-15 is shown and FIG. 18 shows a section view of gasket 102 and body 104 alone line 18-18 of FIG. 15. Gasket 102 is generally elliptical shaped with its major axis along the X-axis with an angled portion 430 connected to either side of a semi-circular shape or arch 190 that arises from a co-vertex of the elliptical shape along the Y-axis. Further, the angled portion 430 is tilted slightly in the Z-axis so that the top face 116 of angled portion 430 and arch 190 is tilted slightly downward approximately 24 degrees in relation to a channel 416. Arch 190 and angled portion 430 provide the ability for gasket 102 to maintain an airtight seal with the skin around a user's nose during a workday, allow a user to wear glasses and provide comfort for a user (see FIG. 22). Gasket 102 is symmetrical about centerline 410 and is configured so bottom face lip 180 circumscribes the area around a person's face and nose to provide prolonged comfort and functionality. In this embodiment edge 133 comprises channel 416 which adheres to body 104 either permanently or removably, thereby securing body 104 to gasket 102 and providing an airtight seal. Channel 416 is shown rectangular in shape and is currently 0.2 inches deep with a width of 0.1 inches, it is contemplated other dimensions may be utilized for a desired fit or manufacturing process. Further, body 104 is large enough to place gasket 102 and channel 416 in tension when body 104 is seated into the channel, even if body 104 is not adhered to channel 416.

Turning to FIG. 18, the connection of body 104 into channel 416 is shown. Further, gasket 102 comprises strip 460 created integral with and located in-line with channel 416 and extending away from channel 416 until it connects with top lip 116. Strip 460 is ideally 0.27 inches wide and provides load transmission from body 104 into gasket 102 at the face, also known as springiness.

Further, gasket 102 comprises one bottom face lip 180 instead of two, first bottom face lip 180 is circumscribed by inner edge 420 and peripheral edge 120. The width of first bottom face lip 180 is a nominal 0.75 inches but may vary between approximately 0.6 inches and 1 inch at different portions of lip 180. For example, the width around the nose (inner hood surface 198) is approximately 0.85 inches to 1 inch while the width near the chin and cheek area 430 is approximately 0.6 inches in order to increase comfort, maintain an air-tight seal and to allow for a user to wear glasses in addition to mask 100. Further, at point 434, located near where lip 180 normally touches the cheeks of a user, peripheral edge 120 on each side of gasket 102 split into beveled edge 432 which extends around the entire chin area/bottom of gasket 102. Beveled edge 432 provides comfort and additional springiness or tension to ensure mask 100 maintains an airtight seal even while a user moves their mouth.

Turning to FIGS. 19-21, a front, bottom and rear view of alternative embodiment of body 104 is shown. Body 104 is also a generally elliptical shaped with its major axis along the X-axis with an angled portion 430 connected to either side of semi-circular shape or arch 440 that arises from a co-vertex of the elliptical shape along the Y-axis. The shape is configured to correlate with the shape of gasket 102. Body 104 is also symmetrical about centerline 410. Turning to the bottom view, one half of body 104 is configured at a 94 angle in relation to the other half, although while this is the preferred angle the angle may change in proportion to the dimensions of body 104 and gasket 102. This angle in the preferred embodiment as at this angle mask 100 hugs a user's face in a way which, combined with the body 104, gasket 102 and filter 114 configuration, reduces the amount of rebreathing already exhaled air. If a user is constantly rebreathing enough previously exhaled air they can eventually feel sick, become dizzy, or pass-out from breathing too much CO2. The angle of body 104 and configuration of body 104, gasket 102 and filter 114 are configured so there is 0.1 liter or less of volume (“dead space”) inside mask 100 when attached to a user.

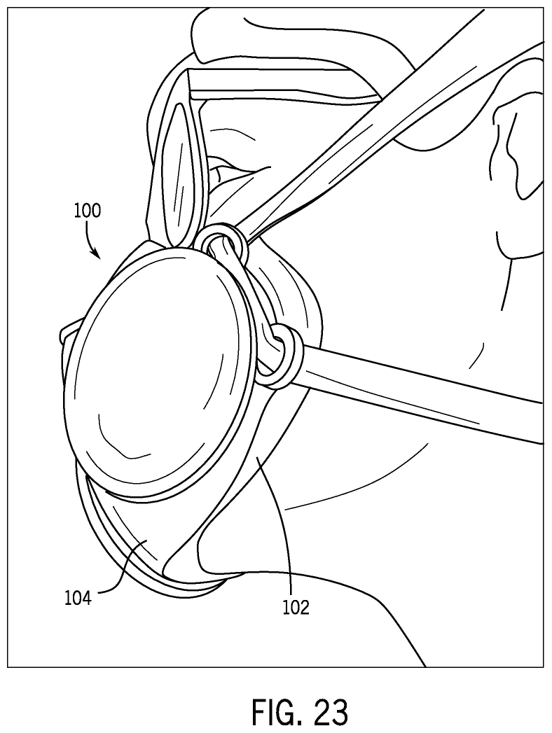

Turning to FIG. 22 a front perspective view of an alternative embodiment of the invention is shown, showing mask 100 being worn by a user. In particular this figure shows how additional material 442, which extends and tapers semicircular shape 190, can comfortably wear glasses on top of mask 100. FIG. 23 a bottom perspective view of an alternative embodiment of gasket 102 is shown showing gasket 102 adhering to, but not covering the chin of a user.

While the present invention has been described above in terms of specific embodiments, it is to be understood that the invention is not limited to these disclosed embodiments. Many modifications and other embodiments of the invention will come to mind of those skilled in the art to which this invention pertain, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An improved reusable respirator mask apparatus comprising:
a gasket with a top face, a bottom face, and a channel located along the edge of the top face;
a body with at least one inlet, at least two head strap mounting positions and at least two neck strap mounting positions; and
a head and neck strap;
wherein the body is secured in the channel of the gasket, the head and neck strap is capable of securing the body and gasket to a user's face by sliding the head and neck strap through the two head strap mounting positions and the two neck strap mounting positions.

2. The apparatus of claim 1 wherein the mask further comprises at least one filter which secures to the body.

3. The apparatus of claim 1 wherein the body is transparent.

4. The apparatus of claim 1 wherein the gasket further comprises additional material to cover a human's nasal bridge.

5. The apparatus of claim 1 wherein the gasket is generally elliptical shaped with its major axis along the X-axis with an angled portion connected on either side of semi-circular shape that arises from a co-vertex of the elliptical shape along the Y-axis.

6. The apparatus of claim 5 wherein the angled portions are tilted slightly downward in relation to top face of the gasket.

7. The apparatus of claim 6 wherein the angled portions are tilted approximately 24 degrees in relation to the top face of the gasket.

8. The apparatus of claim 5 wherein the gasket further comprises a beveled edge.

9. The apparatus of claim 5 wherein the gasket further comprises a strip located in-line with the channel.

10. An improved reusable respirator mask apparatus comprising:
a gasket with a top face, a bottom face, and a channel located along the edge of the top face;
a body with at least one inlet, at least two head strap mounting positions and at least two neck strap mounting positions;
a head and neck strap; and
an adjustable strap clip;
wherein the body is secured in the channel of the gasket, the head and neck strap is capable of securing the body and gasket to a user's face by sliding the head and neck strap through the two head strap mounting positions and the two neck strap mounting positions and securing end of the head and neck strap to the adjustable strap clip.

11. The apparatus of claim 10 wherein the adjustable strap clip is a wedge shape with a concave base.

12. The apparatus of claim 10 wherein the gasket covers the nasal area of a human and is configured to allow glasses or goggles to be worn.

13. The apparatus of claim 10 where the respirator mask is reusable.

14. The apparatus of claim 10 wherein the gasket is formed of a single layer elastomeric material.
